(19) United States
(12) Patent Application Publication
(10) Pub. No.: US 2003/0044608 A1
(43) Pub. Date: Mar. 6, 2003

(54) Nanowire, method for producing the nanowire, nanonetwork using the nanowires, method for producing the nanonetwork, carbon structure using the nanowire, and electronic device using the nanowire

(75) Inventors: Hisae Yoshizawa, Minamiashigara-shi (JP); Kentaro Kishi, Minamiashigara-shi (JP); Kazunaga Horiuchi, Minamiashigara-shi (JP); Masaaki Shimizu, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/082,227

(22) Filed: Feb. 26, 2002

(30) Foreign Application Priority Data
Sep. 6, 2001 (JP) 2001-270808

(51) Int. Cl. D01F 9/12; B32B 1/08

(52) U.S. Cl. 428/398; 423/447.2; 428/367

(57) ABSTRACT

A nanowire including a core portion 12 made of a carbon nanotube having at least one layer of a graphene sheet 12a, 12b, and a functional layer 14 formed around the core portion 12 and having at least one layer of a modified graphene sheet in which a graphene sheet has been modified; a method for producing the nanowire; a nanonetwork using the nanowires; a method for producing the nanonetwork; a carbon structure using the nanowire; and an electronic device using the nanowire.

### BACKGROUND OF THE INVENTION

1. Field of the Invention

The present invention relates to a nanowire using a carbon nanotube, a method for producing the nanowire, a nanonetwork using the nanowires, a method for producing the nanonetwork, a carbon structure using the nanowire, and an electronic device using the nanowire.

The invention can be developed in wide applications of carbon nanotubes.

2. Description of the Related Art

Fibrous carbons are generally called carbon fibers. Research has been heretofore conducted on many kinds of methods for producing carbon fibers used as structural materials having a diameter not smaller than several of μm.

Aside from such carbon fibers, carbon nanotubes discovered in recent years are tubular materials not larger than 1 μm in diameter. As an ideal carbon nanotube, a tube is formed by arranging a sheet-like structure (graphene sheet) of a carbon hexagonal network in parallel with the axis of the tube, and such tubes may be multiplied into layers. Such a carbon nanotube is anticipated theoretically to exhibit metal-like or semiconductor-like properties in accordance with the way of linkage of the hexagonal network made of carbon and the diameter of the tube. Thus, the carbon nanotube is expected as a functional material in the future.

An arc discharge method is generally used for synthesizing a carbon nanotube. Aside from this method, a laser evaporation method, a thermal decomposition method, and a method using plasma are researched in recent years. Here, carbon nanotubes developed in recent years will be reviewed.

Materials whose diameter is not larger than 1 μm and smaller than carbon fibers are commonly called carbon nanotubes, in distinction from carbon fibers. However, there is no particularly clear border between carbon nanotubes and carbon fibers. Strictly, a tube formed by arranging a graphene sheet of a hexagonal network of carbon in parallel with the axis of the tube is called a carbon nanotube (incidentally, this strict interpretation is applied to any carbon nanotube in the invention).

Generally, carbon nanotubes interpreted strictly are further classified as follows. A carbon nanotube formed as a structure of a single graphene sheet is called a single-walled carbon nanotube. On the other hand, a carbon nanotube formed as a structure of multiple layers of graphene sheets is called a multi-walled carbon nanotube. The structure of a carbon nanotube obtained is determined to some extent by a synthesizing method and synthesizing conditions.

The purity of a single-walled carbon nanotube in a product is so low that the carbon nanotube exists in the state where the carbon nanotube is buried in a large quantity of impurities such as amorphous carbon or graphite. However, there is no method to separate the amorphous carbon and the carbon nanotube with high precision. Therefore, when such a single-walled carbon nanotube is used, how to handle amorphous carbon becomes a practical problem.

On the other hand, a multi-walled carbon nanotube can be obtained with a high yield. In addition, residual amorphous carbon is extremely low. Therefore, there is a merit that a high purity carbon nanotube is easily available.

Such carbon nanotubes have higher electric conductivity than that of metal wiring. Accordingly, the carbon nanotubes are expected to be used as electric wiring in nanosized electronic microdevices.

Florian Banhart reports in Nano Letters (Vol. 1(6), 2001, p.329-332) that two carbon nanotubes are bonded by the energy of a beam of electrons by use of amorphous carbon like a paste. Here, the amorphous carbon serving for bonding comes from residues as impurities contained in the carbon nanotubes or carbon compounds in the air aggregated by heating due to the beam of electrons. The carbon nanotubes are connected with each other through such amorphous carbon on the spot irradiated with the beam of electrons.

On the other hand, it is known as a method for changing the electric conductivity of a carbon nanotube that the surface of a single-walled carbon nanotube is fluorinated (“Solubility and Chemical Reaction of Carbon Nanotube” (2001) by Shinohara, p.99-101 in Carbon Nanotube (2001) KAGAKU-DOJIN Publishing Co., LTD.). According to this technique, not the surface of a single carbon nanotube but the circumference of a bundle of a plurality of single-walled carbon nanotubes is fluorinated. As a result, the electric resistance ranging from 5 Ω to 16 Ω increases suddenly to 20 MΩ.

In addition, chemical decoration of a single-walled carbon nanotube has been also researched (“Solubility and Chemical Reaction of Carbon Nanotube” (2001) by Shinohara, p.101-106 in Carbon Nanotube (2001) KAGAKU-DOJIN Publishing Co., LTD.). However, in this technique, the following method is adopted because the chemical reactivity of the surface of a graphene sheet is low. That is, a carbon nanotube is cut short to form an open end, and chemical decoration is performed on the open end. As a method for cutting the carbon nanotube on this occasion, a method using an acid treatment and an ultrasonic treatment in combination is adopted. This is a method in which defects are produced in a side surface of a single-walled carbon nanotube by the ultrasonic treatment in an acidic solution, and the single-walled carbon nanotube is cut therein. By such a method, the carbon nanotube is cut to be short (about several hundreds of nm). The carbon nanotube having an end portion subjected to such chemical decoration can be dissolved in a solvent in accordance with the form of the chemical decoration.

Further, as disclosed in Japanese Patent No. 2595903, the surface of a carbon nanotube can be chemically decorated with an acid treatment. However, differently from the end portion, the surface is poor in reactivity. Thus, the denatured ratio on an atomicity basis is lower than 10%.

There is another method for decorating the surface of a carbon nanotube. That is, as disclosed in Japanese Patent Laid-Open No.Hei.8-209126, a carbon nanotube is exposed to a hydrogen or methane atmosphere at a high temperature for a long time so that the surface of the carbon nanotube is ring-opened, and hydrogenated or methanated. Also in this method, only a part of a graphene sheet in the surface is denatured.

Carbon nanotubes have excellent and unprecedented properties such as high electric conductivity, toughness, or chemical stability. When carbon nanotubes are used as they are, there is a limit on the range of applications. It is therefore necessary to provide a structure in which a carbon nanotube is disposed in a functional layer having another function so that the function of the carbon nanotube can be utilized effectively. However, due to the properties of the carbon nanotube, it is difficult to dispose the carbon nanotube stably in the functional layer. Generally, when chemical bonding is attempted to dispose the carbon nanotube in the functional layer stably, those excellent properties of the nanotube are impaired.

For example, in the technique in which two carbon nanotubes are bonded by the energy of a beam of electrons by use of amorphous carbon like a paste as described previously, the carbon nanotubes are fixed to each other simply by the amorphous carbon aggregated on the surfaces of graphene sheets of the carbon nanotubes. In consideration of an electric network, it is therefore difficult to keep the connection stable.

In addition, it can be considered that single-walled carbon nanotubes having surfaces insulated by the technique of fluorinating the surfaces as described previously are connected with each other for use as wiring. However, such wires themselves exhibit high resistivity. Even if these wires are brought into contact with each other and fixed through amorphous carbon, the electric resistivity is so high that it is difficult to form network wiring. It can be considered that fluorine adhering to the surfaces is removed suitably or adhesion of fluorine is selectively prevented to ensure electrically connected portions. Alternatively, it can be considered that electric connection is made only through the ends of nanowires to which no fluorine adheres. However, the productivity to make a large number of electric connections is extremely low.

Further, chemical decoration of the side surface of a carbon nanotube is being implemented only in a single-walled carbon nanotube as described previously. However, the single-walled carbon nanotube has only one layer of a graphene sheet. When chemical decoration is carried out on the only one layer, the graphene sheet is denatured and a double bond is lost to thereby cause deterioration in the properties of the carbon nanotube, such as lowering in electric conductivity.

In consideration of use of a large volume of high-purity carbon nanotubes, it is preferable that multi-walled carbon nanotubes easily available can be used. However, since multi-walled carbon nanotubes are generally poor in reactivity, specific methods for chemically decorating the surface of a multi-walled carbon nanotube sufficiently are still unknown so far. Further, in a related-art chemical decoration method in which ligands can be bonded only to an outermost graphene sheet layer, a carbon nanotube cannot be buried in a functional layer due to an insufficient degree of denaturalization. Thus, the functional layer cannot be made to adhere to the carbon nanotube stably or to have a sufficient function as the functional layer.

### SUMMARY OF THE INVENTION

The invention was developed in consideration of the foregoing problems. An object of the invention is to provide a novel nanowire using a carbon nanotube and a method for producing the nanowire. Another object of the invention is to provide a method for simply and easily producing a nanonetwork having such nanowires so as to improve the handling performance of carbon nanotubes, and so as to implement a wide range of applications of carbon nanotubes, such as electronic devices or functional materials containing the carbon nanotubes, and other structural materials.

The foregoing objects are attained by the invention as follows.

That is, a nanowire according to a first aspect of the invention includes a core portion having a carbon nanotube having at least one layer of a graphene sheet and a functional layer formed around the core portion and having at least one layer of a modified graphene sheet.

According to the first aspect of the invention, the core portion of the carbon nanotube having at least one layer of a graphene sheet exists in the center of the nanowire. Thus, the properties of the carbon nanotube can be utilized as they are. At the same time, the functional layer having at least one layer of a modified graphene sheet is provided around the carbon nanotube formed as the core portion. Thus, bonds of carbons with one another are intertangled sufficiently so that the functional layer is retained stably on the core portion. Further, since a large number of bonds are formed in the surface of the modified graphene sheet forming the functional layer, it is also easy to carry out chemical decoration.

Incidentally, the term “modified” in the invention mainly means the state where the network structure of six-membered rings forming a graphene sheet has been partially broken. Here the term “broken” means that π bonding or σ bonding in the network structure of six-membered rings is ring-opened so that the original structure of the graphene sheet is lost partially. The “broken” state does not include the state where the graphene sheet structure is perfectly broken so that the graphene sheet is wholly released from the core portion, but includes the state where the graphene sheet structure is partially released from the core portion.

In addition, the meaning of the term “modified” also includes the state where chemical decoration has been carried out on six-membered rings forming a graphene sheet. However, in this case, only the following three states are included in the concept of the term “modified” in the invention.

The state where chemical decoration has been carried out on a broken portion in which the network structure of six-membered rings forming a graphene sheet has been broken partially.

The state where chemical decoration has been carried out over a region of two or more layers of graphene sheets.

The state where the network structure of six-membered rings forming at least one layer of a graphene sheet has been partially broken while chemical decoration has been carried out on another layer of a graphene sheet.

In the modified graphene sheet, an amorphous carbon area may be included, or a structure different in structure from a graphene sheet may be bonded with modified carbon atoms. The structure may be a functional molecule.

The functional layer may have insulating properties or semiconductor properties. Other materials may be dispersed in the functional layer. Examples of such other materials include doping agents or functional molecules.

A predetermined material may be incorporated in a hollow tubular portion of the carbon nanotube forming the core portion.

The carbon nanotube forming the core portion may have either a structure exhibiting semiconductor properties or a structure exhibiting conductor properties, and can be selected in accordance with the intended use.

According to a second aspect of the invention, a nanonetwork includes a plurality of nanowires according to the first aspect of the invention to form a network structure in which the functional layers of the nanowires are fused with one another at least in the side surfaces of the nanowires.

According to the second aspect of the invention, a core portion of a carbon nanotube having at least one layer of a graphene sheet exists in the center of each of the nanowires. Thus, it is possible to build a minute nanonetwork utilizing the properties of carbon nanotubes as they are. At the same time, the functional layer having at least one layer of a modified graphene sheet is provided around the carbon nanotube formed as the core portion. Thus, bonds of carbons with one another are intertangled sufficiently, so that the functional layer is retained stably on the core portion while the functional layer is firmly connected to other nanowires. Thus, it is possible to obtain a stable and solid nanonetwork. Further, since a large number of bonds are formed in the surface of the modified graphene sheet forming the functional layer, it is also easy to carry out chemical decoration.

According to a third aspect of the invention, a carbon structure includes a multi-walled carbon nanotube having at least two layers of graphene sheets, and an amorphous carbon area at which a graphene sheet forming an outermost layer of the carbon nanotube is partially connected with at least one graphene sheet forming an inner layer of the carbon nanotube.

According to the third aspect of the invention, the amorphous carbon area is brought into electric connection not only with the surface graphene sheet but also with the inner graphene sheet. Accordingly, an electric current can be made to flow not only into the graphene sheet in the surface of the multi-walled carbon nanotube but also into the inner-layer graphene sheet through the amorphous carbon area. Thus, the electric current density can be increased. In addition, a plurality of graphene sheets having structures different in conductivity properties and semiconductor properties may be combined to form a multi-carbon nanotube. In this case, when an outer layer and an inner layer are connected through an amorphous carbon area, the multi-walled carbon nanotube can be used as a semiconductor device.

According to a fourth aspect of the invention, a method for producing a nanowire has the step of carrying out at least a modification treatment on a multi-walled carbon nanotube having at least two layers of graphene sheets so as to produce a nanowire having a core portion and a functional layer, the core portion having a carbon nanotube having at least one layer of the graphene sheets, the functional layer formed around the core portion and having a modified graphene sheet originated from at least one of the graphene sheets around the core portion.

According to the fourth aspect of the invention, various modification treatments may be carried out so that a nanowire according to the first aspect of the invention can be produced to have a desired structure.

Examples of the modification treatments include a mechanochemical treatment, a heating treatment, an acidic solvent treatment, and an ultrasonic treatment. It is preferable to adopt the mechanochemical treatment because a graphene sheet in the side surface of a multi-walled carbon nanotube can be modified in a short time while the length as a carbon nanotube is maintained thoroughly or to some extent. In addition to the mechanochemical treatment, it is more preferable to use, in combination, at least one treatment selected from a group of a heating treatment, an acidic solvent treatment and an ultrasonic treatment.

As for the degree of the modification treatment, the modification treatment may be carried out 1) till hollow tubular portions surrounded by a graphene sheet originated from the carbon nanotube of the core portion and node portions separating the hollow tubular portions are formed alternately in the nanowire in the longitudinal direction of the nanowire, 2) till defects are produced at least in the surface of the multi-walled carbon nanotube so that a carbon nanotube having a hollow tubular portion surrounded by a graphene sheet is left as the core portion while the modified graphene sheet originated from at least one of graphene sheets is formed around the core portion (particularly till the modified graphene sheet has an amorphous carbon area), or 3) till defects are produced at least in the surface of the multi-walled carbon nanotube so that a carbon nanotube having a hollow tubular portion surrounded by a graphene sheet is left as the core portion while the modified graphene sheet originated from at least one of graphene sheets and which has an amorphous carbon area is formed around the core portion, and a network structure in which a plurality of such nanowires adhere to one another through the amorphous carbon areas is formed.

The multi-walled carbon nanotube used for producing a nanowire may have three or more layers. In such a case, the functional layer may have two or more layers of modified graphene sheets.

According to a fifth aspect of the invention, a method for producing a nanonetwork has a feature as follows. That is, a nanowire according to the first aspect of the invention in which the modified graphene sheet has an amorphous carbon area (hereinafter occasionally referred to as “nanowire A”) and a nanowire according to the first aspect of the invention (An amorphous carbon area may be either present or absent. This nanowire will be occasionally referred to as “nanowire B”.) or a carbon nanotube are crossed so that the amorphous carbon area in the nanowire A is in contact with the nanowire B or the carbon nanotube. The crossing portion is irradiated with a beam of electrons so as to electrically connect the nanowire A with the nanowire B or the carbon nanotube.

According to the fifth aspect of the invention, the connection between the nanowires or between the nanowire and the carbon nanotube is achieved through amorphous carbon derived from the graphene sheet of the nanowire. Accordingly, the nanowires, or the nanowire and the carbon nanotube can be electrically and firmly connected by simply irradiating the crossing portion with a beam of electrons. Thus, a solid nanonetwork can be produced easily.

According to a sixth aspect of the invention, an electronic device includes a nanowire according to the first aspect of the invention used as electric wiring.

According to the sixth aspect of the invention, because the nanowire according to the first aspect of the invention which have excellent properties described above or which can be made to keep desired properties is used, it is possible to obtain electronic devices having various functions in accordance with those excellent properties.

### BRIEF DESCRIPTION OF THE DRAWINGS

FIG. 1 is a schematically enlarged sectional view showing a first embodiment of a nanowire according to the invention.

FIGS. 2A to 2C are schematically explanatory views for explaining a modified portion in a modified graphene sheet, FIG. 2A showing a network structure of six-membered rings in a graphene sheet, FIG. 2B showing the state where the network structure of the six-membered rings in the graphene sheet has been partially broken and formed into amorphous carbon, FIG. 2C showing the state where functional molecules have been bonded to the modified graphene sheet.

FIG. 3 is a schematically enlarged sectional view showing a second embodiment of a nanowire according to the invention.

FIG. 4 shows the nanowire observed by transmission electron microscope in FIG. 3.

FIG. 5 is a schematically enlarged sectional view showing a third embodiment of a nanowire according to the invention.

FIG. 6 is a schematically enlarged sectional view showing a fourth embodiment of a nanowire according to the invention.

FIG. 7 is a schematically enlarged sectional view showing a fifth embodiment of a nanowire according to the invention.

FIG. 8 is a schematically enlarged sectional view showing a sixth embodiment of a nanowire according to the invention.

FIG. 9 is a schematically enlarged sectional view showing a seventh embodiment of a nanowire according to the invention.

FIG. 10 is a schematically enlarged sectional view showing an eighth embodiment of a nanowire according to the invention.

FIG. 11 shows nanowires (nanonetwork) (representative of the invention) observed by scanning electron microscope in Example.

FIGS. 12A and 12B are schematically enlarged views for explaining the state of a crossing portion in a nanonetwork, FIG. 12A showing a simply crossing portion between carbon nanotubes, FIG. 12B showing crossing portion in a nanonetwork according to the invention.

FIG. 13 is a schematically enlarged sectional view showing an embodiment of a carbon structure according to the invention.

FIGS. 14A and 14B are schematically explanatory views for explaining the principle in a method for producing a nanonetwork according to the invention.

FIG. 15 shows nanowires (nanonetwork) observed by scanning electron microscopic in Reference Example.

FIG. 16 is a graph showing electric properties of nanowires (nanonetworks) in Example and Reference Example.

FIG. 17 shows nanowires (nanonetwork) observed by scanning electron microscopic in another Example.

### DETAILED DESCRIPTION OF THE PREFERRED EMBODIMENTS

The invention will be described below in detail sequentially from its first aspect.

[First Aspect of the Invention]

The first aspect of the invention will be described with its preferred embodiments. Incidentally, a method for producing a nanowire according to the following embodiments will be described in detail in the section of [Fourth Aspect of the Invention].

<First Embodiment>

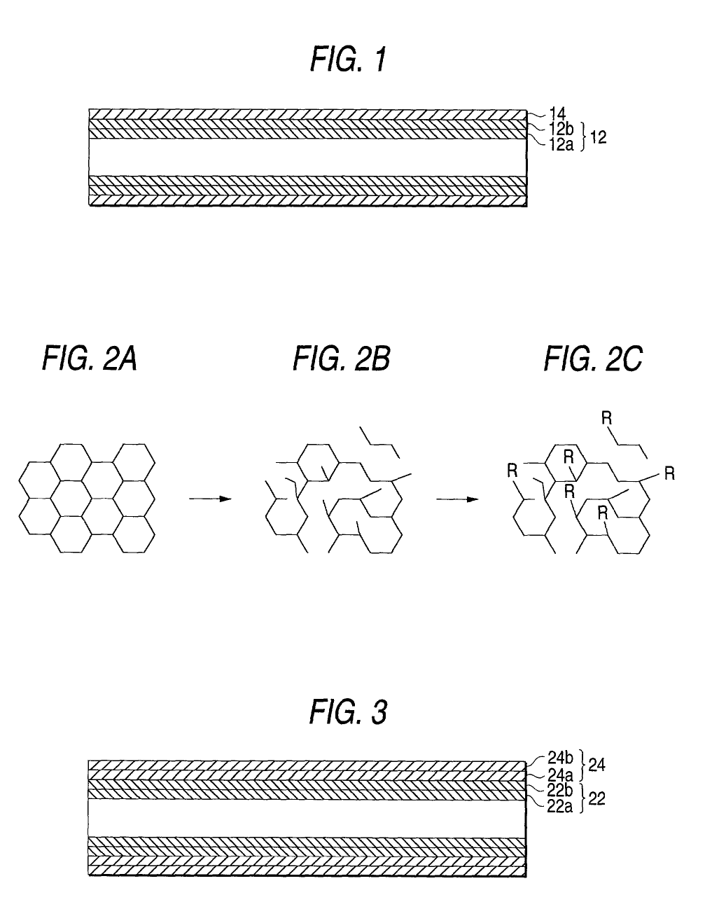

FIG. 1 is a schematically enlarged sectional view of a nanowire according to a first embodiment. As shown in FIG. 1, the nanowire according to this embodiment has a core portion 12 and a functional layer 14 around the core portion 12. The core portion 12 is made of a cylindrical carbon nanotube having two layers of graphene sheets 12a and 12b. The functional layer 14 has a layer of a modified graphene sheet in which a graphene sheet has been modified.

The modified graphene sheet forming the functional layer 14 is broken partially structurally, and the structurally broken portion becomes an amorphous carbon area.

FIGS. 2A to 2C show schematically explanatory views for explaining the modified portion in the modified graphene sheet. A graphene sheet of a carbon nanotube has a network structure of six-membered rings as shown in FIG. 2A. When the network structure is modified by suitable treatment, the network structure of six-membered rings is broken partially and brought into a state where there appear bonds which are free to some extent as shown in FIG. 2B. In the invention, such a state where the network structure of six-membered rings is broken so that not a single bond is free to some extent but some area of such bonds appear is referred to as “amorphous-carbon-like”, and such an amorphous-carbon-like portion is referred to as “amorphous carbon area”.

Incidentally, if only a small part of bonding in the six-membered rings is cut off, the modified portion cannot function as the functional layer 14. It is therefore desired that such a modified portion exist around the graphene sheet in accordance with the purpose of the functional layer. Therefore, in the invention, modification is desirably made to such a degree that a functional layer exists to make the electric properties of the nanowire change by 10% or more.

According to this embodiment, the properties of the carbon nanotube can be utilized as it is because the core portion 12 of the carbon nanotube having two layers of graphene sheets 12a and 12b exists in the center of the nanowire. At the same time, because the functional layer 14 having one layer of a modified graphene sheet is provided around the carbon nanotube formed as the core portion 12, bonds of carbons are sufficiently intertangled with one another. Thus, the functional layer 14 is retained stably on the core portion 12. Further, a large number of bonds are formed in the surface of the modified graphene sheet forming the functional layer 14. Thus, it is easy to carry out chemical decoration.

Since the functional layer 14 has a modified graphene sheet, double bonds forming six-membered rings are partially broken so that there appear bonds. When the volume of modification of the graphene sheet is increased, an amorphous carbon coat intertangled with the core portion 12 having a carbon nanotube can be formed.

A carbon nanotube shows conductor properties or semiconductor properties in accordance with the positions of carbons connected when a graphene sheet is formed into a cylindrical shape. The electric conductivity when the carbon nanotube shows semiconductor properties is generally very high, ranging from 10⁸ S/cm to 10⁹ S/cm. On the other hand, the electric conductivity of amorphous carbon is about 100 S/cm, having significantly higher resistance than that in the carbon nanotube formed as the core portion. Accordingly, the nanowire in this embodiment becomes a nanowire having electric properties different from those in a normal carbon nanotube in which a graphene sheet in the surface is not modified.

Further, when a plurality of nanowires each having such a structure according to this embodiment are brought into contact with one another, an electric current can be made to flow into the nanowires through contact points thereof. In the modified graphene sheet, a graphene sheet structure is left behind and intertangled with the carbon nanotube. Thus, the modified graphene sheet has high adhesion force to the carbon nanotube so that stable electric connection can be achieved. In other words, in the nanowire according to this embodiment, there is formed a functional layer which makes stable electric connection with other nanowires easily without losing the electric properties of the carbon nanotube.

<Second Embodiment>

FIG. 3 is a schematically enlarged sectional view of a nanowire according to a second embodiment. As shown in FIG. 3, the nanowire according to this embodiment has a core portion 22 and a functional layer 24 around the core portion 22. The core portion 22 has a cylindrical carbon nanotube having two layers of graphene sheets 22a and 22b. The functional layer 24 has two layers of modified graphene sheets 24a and 24b in which graphene sheets have been modified.

The modified graphene sheets 24a and 24b forming the functional layer 24 are broken partially structurally, and the structurally broken portion becomes an amorphous carbon area. Specifically, the structure of the surface-side modified graphene sheet 24b is broken to form an amorphous carbon area, while the structure of the center-side modified graphene sheet 24a is not perfectly broken but bonds constructing the network are cut partially.

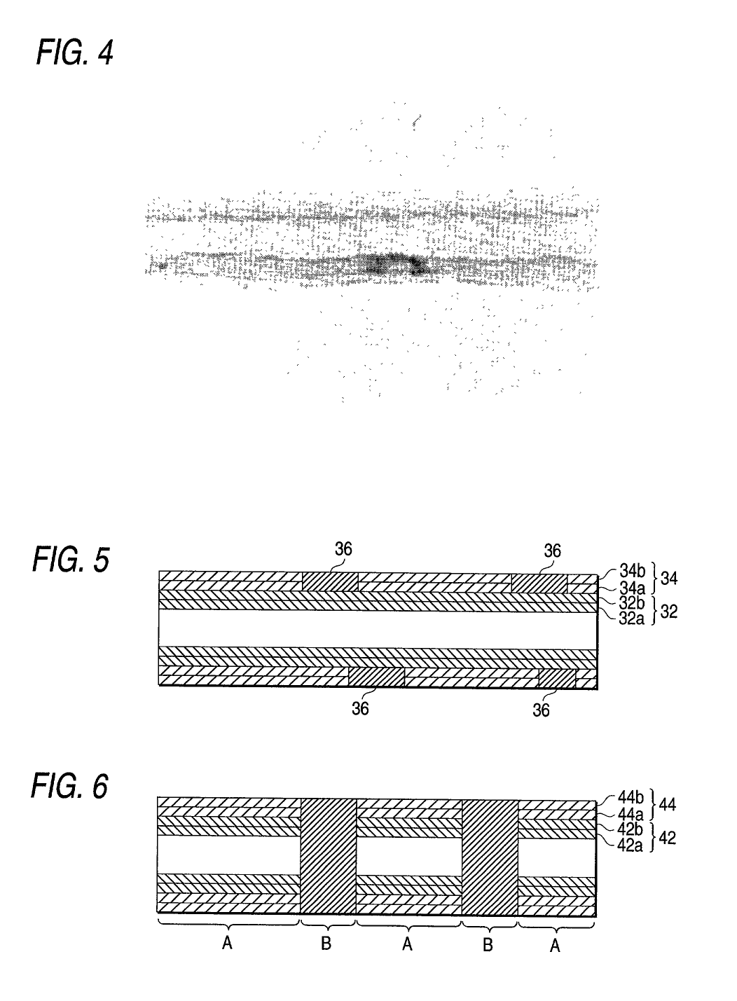

FIG. 4 shows a nanowire according to this embodiment observed by transmission electron microscopic (magnification ×600, 000). Incidentally, the magnification of the drawing has a minor error in accordance with the degree of enlargement of the drawing (hereinafter, the same thing will be applied to all the drawings). In addition, a multi-walled carbon nanotube used to form the nanowire in the drawing has a six- or seven-layer structure, and does not strictly have the same structure as the nanowire according to this embodiment.

As is understood from FIG. 4, a carbon nanotube can be seen in the center but looks fuzzier in a portion closer to the outer circumferential portion. This is because the graphene sheet structure closer to the outer circumferential portion is more modified. As described previously, the multi-walled carbon nanotube used to form the nanowire in the drawing has a structure of six or seven layers. Of them, approximately two outer-circumferential layers are the graphene sheets forming a functional layer.

According to this embodiment, the properties as the carbon nanotube can be utilized as they are because the core portion 22 of the carbon nanotube having two layers of graphene sheets 22a and 22b exists in the center of the nanowire. At the same time, because the functional layer 24 having two layers of modified graphene sheets 24a and 24b is provided around the carbon nanotube formed as the core portion 22, bonds of carbons with one another are intertangled sufficiently. Thus, the functional layer 24 is retained stably on the core portion 22. Further, a large number of bonds are formed in the surfaces of the modified graphene sheets 24a and 24b forming the functional layer 24. Thus, it is easy to carry out chemical decoration. Other operations and effects similar to those in the first embodiment are provided.

In the invention, it is preferable that the number of layers of modified graphene sheets are two or more as that in this embodiment so as to form the structure intertangled with the core portion stably.

<Third Embodiment>

FIG. 5 is a schematically enlarged sectional view of a nanowire according to a third embodiment. As shown in FIG. 5, the nanowire according to this embodiment has a core portion 32 and a functional layer 34 around the core portion 32. The core portion 32 has a cylindrical carbon nanotube having two layers of graphene sheets 32a and 32b. The functional layer 34 has two layers of modified graphene sheets 34a and 34b in which graphene sheets have been modified.

The modified graphene sheets 34a and 34b forming the functional layer 34 are broken structurally over an extensive region, and formed into amorphous carbon (extensive broken portions 36). The broken state is beyond the partially broken state in the first or second embodiment. That is, in the extensive broken portions 36, the network structures of the modified graphene sheets 34a and 34b are broken perfectly so that both the modified graphene sheets 34a and 34b are connected through the amorphous carbon in the extensive broken portions 36. Not to say, an amorphous carbon area may be present in any portion of the modified graphene sheets 34a and 34b other than the extensive broken portions 36.

According to this embodiment, the properties as the carbon nanotube can be utilized as they are because the core portion 32 of the carbon nanotube having two layers of graphene sheets 32a and 32b exists in the center of the nanowire. At the same time, because the functional layer 34 having two layers of modified graphene sheets 34a and 34b is provided around the carbon nanotube formed as the core portion 32, bonds of carbons with one another are intertangled sufficiently as a whole though there is extensive broken portions 36 in the modified graphene sheets 34a and 34b. Thus, the functional layer 34 is retained stably on the core portion 32. Further, a large number of bonds are formed in the surfaces of the modified graphene sheets 34a and 34b forming the functional layer 34. Thus, it is easy to carry out chemical decoration.

In addition, because the two layers of modified graphene sheets 34a and 34b are electrically connected through the extensive broken portions 36, the nanowire can be used as a desired electric device by suitably adjusting the electric properties of the two layers of modified graphene sheets 34a and 34b.

<Fourth Embodiment>

FIG. 6 is a schematically enlarged sectional view of a nanowire according to a fourth embodiment. As shown in FIG. 6, the nanowire according to this embodiment has a core portion 42 and a functional layer 44 around the core portion 42. The core portion 42 has a cylindrical carbon nanotube having two layers of graphene sheets 42a and 42b. The functional layer 44 has two layers of modified graphene sheets 44a and 44b in which graphene sheets have been modified.

In this embodiment, not only the functional layer 44 having the two layers of modified graphene sheets 44a and 44b but also the core portion 42 having a carbon nanotube having the two layers of graphene sheets 42a and 42b are modified into amorphous carbon (node portions B). That is, in the nanowire in this embodiment, hollow tubular portions A surrounded by the graphene sheets 42a and 42b derived from the carbon nanotube of the core portion 42 and node portions B in which the hollow tubular portions A are narrowed are formed alternately in a longitudinal direction. That is, in the nanowire according to this embodiment, the two layers of graphene sheets 42a and 42b of the carbon nanotube formed as the core portion 42 are partially modified by the modification treatment.

In the invention, the graphene sheets 42a and 42b are not required to be free from modification over the whole length of the carbon nanotube formed as the core portion 42. As shown in this embodiment, the carbon nanotube of the core portion 42 may be cut intermittently in the length direction thereof. In this case, the carbon nanotube forming the core portion 42 is put into the condition of an aggregate of short carbon nanotubes. Because electric conductivity can be left also in the modified graphene sheets 44a and 44b in the functional layer 44, the nanowire can be provided with a function as a conductive wire. In addition, by adjusting the cutting intervals of the carbon nanotube by the node portions B, the electric resistance can be also adjusted. Thus, the nanowire can be used as a resistance wire.

<Fifth Embodiment>

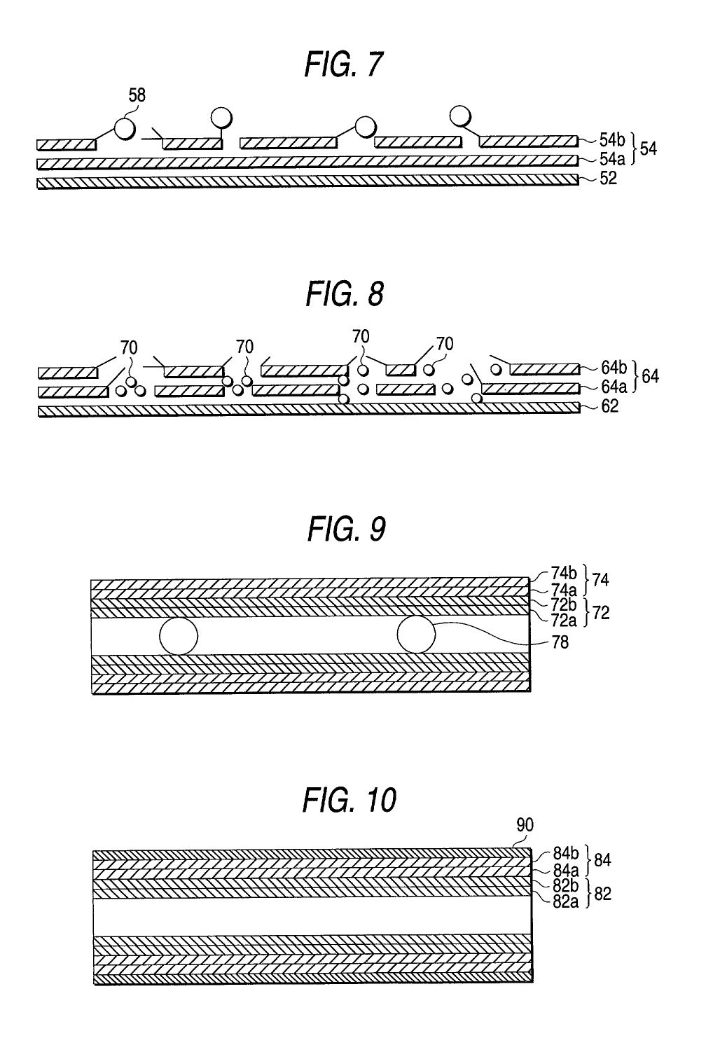

FIG. 7 is a schematically enlarged sectional view showing only the portions of respective layers in a nanowire according to a fifth embodiment in higher magnification. As shown in FIG. 7, the nanowire according to this embodiment has a core portion 52 and a functional layer 54 around the core portion 52. The core portion 52 has a cylindrical carbon nanotube having a layer of a graphene sheet. The functional layer 54 has two layers of modified graphene sheets 54a and 54b in which graphene sheets have been modified.

As for the structure of the surface-side modified graphene sheet 54b, a large number of bonds forming a network are cut off, and structures 58 different in structure from the graphene sheet are bonded to some of the cut-off bonds. Incidentally, the structure of the center-side modified graphene sheet 54a is not perfectly broken, and bonds forming a network are partially cut off (not shown).

The bonding of the structures 58 to the modified graphene sheet 54b can be described with reference to FIGS. 2A to 2C. That is, when the graphene sheet of the carbon nanotube before modification shown in FIG. 2A is brought into the state shown in FIG. 2B as the modification advances, the network structure of six-membered rings is partially broken as illustrated. Thus, there appear bonds free to some extent. The portions of such bonds have good reactivity so that structures such as functional molecules R can be bonded thereto easily as shown in FIG. 2C.

The structures 58 to be bonded may be amorphous substances such as amorphous carbon, as well as atoms or molecules so long as the structure 58 is structures different in structure from a graphene sheet.

For example, fluorine may be bonded to modified carbon atoms of the modified graphene sheet 54b. Thus, insulating properties can be given to the modified graphene sheet 54b, further to the functional layer 54. In addition, by controlling the quantity of such bonding to some extent, semiconductor properties can be given to the modified graphene sheet 54b, further to the functional layer 54.

Alternatively, when structures (such as functional molecules) having functionality involving in electric conductivity and/or magnetic properties are used as the structures 58, a function corresponding to the functionality can be given to the functional layer. Thus, it is possible to obtain a nanowire having desired properties.

Examples of such structures having the functionality include atoms, molecules, ions, crystals, particles, polymers, and molecules or textures extracted from organisms. Examples of properties belonging to such structures include insulating properties, conductivity, semiconductivity (meaning a concept including both semiconductor properties and electric resistance properties), absorptivity, luminescence properties, elasticity, coloring properties, electric generating properties, or photoelectric properties. These properties may be changeable in accordance with temperature, humidity or atmospheric gas.

Alternatively, the structures 58 may be functional molecules or functional particles having a designed function. In recent years, many semiconductor properties have been discovered in many molecules and particles, which can give a switching function or a memory function to the surface of a graphene sheet of a carbon nanotube.

As for the functional molecules, it is preferable that charges inside the molecules are biased. Examples of such molecules include molecules in which molecular species having charge donating properties and molecular species having charge receiving properties have been combined, molecules in which molecular species having charge donating properties or charge receiving properties have been combined with symmetrical molecules, macromolecules formed by repeating those molecules, or molecular aggregates functioning due to molecular association of molecular aggregates. Incidentally, the charge donating properties and the charge receiving properties can be defined by the value of electron affinity or ionization potential.

Alternatively, biomolecules such as DNA or collagen, or artificial molecules imitating organisms may be used. In such a case, a function similar to an organism can be given.

It was hitherto difficult to bond other molecules to a graphene sheet in the surface of a carbon nanotube. According to the method for producing a nanowire in the fourth aspect of the invention which will be described later, however, it is possible to bond functional molecules to a modified portion of a modified graphene sheet. Thus, as shown in this embodiment, options of available materials are expanded broadly.

In addition, in a related-art denatured nanowire in which another structure was bonded to a single-walled carbon nanotube, the structure of a graphene sheet changed so that the electric properties originally belonging to the carbon nanotube could not be utilized effectively. As shown in this embodiment, however, the structure of a carbon nanotube is kept as the core portion 52. It is therefore possible to utilize the properties of the carbon nanotube effectively.

In recent years, many semiconductor properties have been discovered in many molecules and particles. A switching function or a memory function may be chemically bonded to a multi-walled carbon nanotube in advance so that a graphene sheet in a surface layer can be modified later.

<Sixth Embodiment>

FIG. 8 is a schematically enlarged sectional view showing only the portions of respective layers in a nanowire according to a sixth embodiment in higher magnification. As shown in FIG. 8, the nanowire according to this embodiment has a core portion 62 and a functional layer 64 around the core portion 62. The core portion 62 has a cylindrical carbon nanotube having one layer of a graphene sheet. The functional layer 64 has two layers of modified graphene sheets 64a and 64b in which graphene sheets have been modified.

In the structure of the surface-side modified graphene sheet 64b, a large number of bonds forming a network are cut off. Also in the center-side modified graphene sheet 64a, bonds forming a network are partially cut off.

In the fifth embodiment, structures such as functional molecules other than a graphene sheet were bonded to the portions of such bonds in this state. In this embodiment, in place of such structures, other materials 70 are dispersed into spaces of modified portions. Thus, a desired function can be exhibited in accordance with the function of the other materials 70. In the related art, other materials such as molecules could not be dispersed (diffused) into a graphene sheet structure in the surface of a carbon nanotube. As shown in this embodiment, however, other materials can be easily dispersed into modified portions in a modified graphene sheet.

In this embodiment, as such other materials that can be dispersed into the functional layer 64 having the modified graphene sheets 64a and 64b, structures similar to those in the fifth embodiment, that is, functional molecules or functional particles having a designed function, as well as atoms and molecules, may be used so that properties corresponding to their function can be given to the nanowire.

Alternatively, as such other materials, a doping agent may be dispersed. By dispersing the doping agent, semiconductor-like properties can be given to the nanowire. The doping agent that can be added is not limited specifically. Any doping agent exemplified in the field of semiconductors can be adopted as it is. Specific examples of such doping agents include aluminum, antimony, arsenic, gallium, indium, gold, platinum, oxygen, nitrogen, silicon, boron, titanium, and molybdenum.

In order to obtain nanowires according to this embodiment, such other materials may be disposed in and/or near gaps among such carbon nanotubes by: a method such as vacuum deposition, in which the carbon nanotubes are exposed to the vapor of materials; a method like dyeing, in which a solution containing desired materials is dropped onto the carbon nanotubes or the carbon nanotubes are impregnated with such a solution; a method in which the temperature of the carbon nanotubes is increased and decreased repeatedly so as to produce minute cracks due to a difference in thermal expansion coefficient, and materials are infiltrated into the minute cracks; or a method in which electrons, atoms, ions, molecules or particles accelerated are driven into the carbon nanotubes.

As a modification of this embodiment, a plurality of nanowires according to the first embodiment may be connected through modified graphene sheets in their side surfaces. Then, functional polymers can be bonded or dispersed to make the nanowires insulated except the connection points of the modified graphene sheets. In such a manner, it is possible to obtain a network wiring structure in which nanowires are electrically connected stably and also insulated from one another.

<Seventh Embodiment>

FIG. 9 is a schematically enlarged sectional view of a nanowire according to a seventh embodiment. As shown in FIG. 9, the nanowire according to this embodiment has a core portion 72 and a functional layer 74 around the core portion 72. The core portion 72 has a cylindrical carbon nanotube having two layers of graphene sheets 72a and 72b. The functional layer 74 has two layers of modified graphene sheets 74a and 74b in which graphene sheets have been modified. That is, the nanowire according to this embodiment has a basic structure similar to that of the nanowire according to the second embodiment.

In this embodiment, predetermined materials 78 are incorporated into a hollow tubular portion of the carbon nanotube forming the core portion 72.

As the predetermined materials 78, structures similar to those in the fifth embodiment, that is, functional molecules or functional particles having a designed function, as well as atoms and molecules, may be used so that properties corresponding to their function can be given to the nanowire. For example, functional molecules such as fullerenes, or metal elements can be incorporated in the center.

<Eighth Embodiment>

FIG. 10 is a schematically enlarged sectional view of a nanowire according to an eighth embodiment. As shown in FIG. 10, the nanowire according to this embodiment has a core portion 82 and a functional layer 84 around the core portion 82. The core portion 82 has a cylindrical carbon nanotube having two layers of graphene sheets 82a and 82b. The functional layer 84 has two layers of modified graphene sheets 84a and 84b in which graphene sheets have been modified. That is, the nanowire according to this embodiment has a basic structure similar to that of the nanowire according to the second embodiment.

In this embodiment, a second functional layer 90 having a different structure from that of the functional layer 84 is provided as an outer layer than the functional layer 84. By providing the second functional layer 90, a further function can be given to the nanowire in accordance with the function of the second functional layer 90.

For example, when the nanowire is coated with a polymer film so as to provide the second functional layer 90, a function of protecting the core portion 82 having a carbon nanotube and the functional layer 84 having the modified graphene sheets 84a and 84b, a function of fixing them, and a function of insulating the inside from the outside can be given to the nanowire. When the functional layer 84 having the modified graphene sheets 84a and 84b is designed so that structures or other materials are bonded and/or dispersed into the modified graphene sheets as shown in the fifth embodiment or the sixth embodiment, particularly those structures or other materials can be firmly fixed.

The first aspect of the invention is described above in detail with its preferred embodiments. The invention is not limited to the embodiments. As long as the gist of the invention is not changed, those skilled in the art can carry out modification and/or addition on the invention on the basis of known information.

Nanowires according to the first aspect of the invention can be used as electronic devices by use of their electric properties. In addition, the nanowires can be used as electrodes by use of their conductivity and corrosion resistance. Further, apart from electronic applications, the nanowires can be used as various structural materials (chassis, frames, and other mechanical parts) by use of their extremely high toughness. More specific applications will be described later.

[Second Aspect of the Invention]

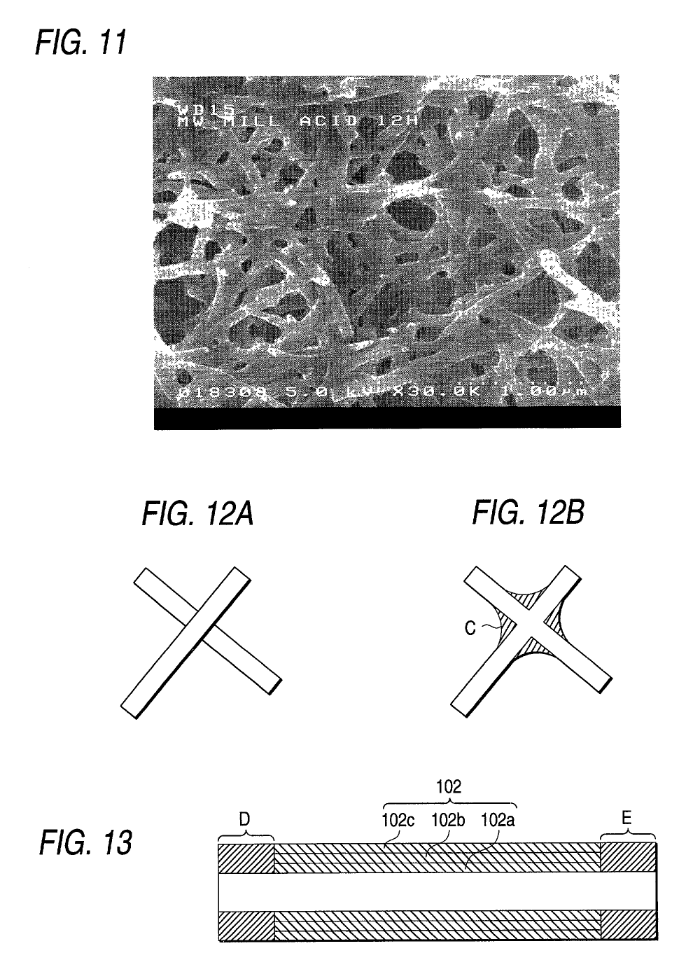

The second aspect of the invention is a nanonetwork having a plurality of nanowires according to the first aspect of the invention to form a network structure in which the functional layers of the nanowires adhere to one another at least in their side surfaces. FIG. 11 shows a nanonetwork according to the second aspect of the invention observed by scanning electron microscope (magnification ×30,000, the drawing is the same as nanowires in Example 1 which will be described later).

FIG. 11 shows the state where nanowires are bonded and fused to one another through modified graphene sheets which are functional layers of the nanowires. Usually, when a network is formed from a simple aggregate of nanotubes, it is understood that carbon nanotubes are in contact with each other at an angle in the crossing portion of the both as shown in FIG. 12A. In the second aspect of the invention, however, as is understood from FIG. 11, amorphous carbon C derived from modified graphene sheets clings to around nanowires in the crossing portion of the both so as to bond the both with each other firmly.

Incidentally, the method for producing a nanonetwork according to the second aspect of the invention will be described together with the method for producing a nanowire in the clause of [Fourth Aspect of the Invention] which will be described later.

According to the second aspect of the invention, a core portion of a carbon nanotube having at least one layer of a graphene sheet exists in the center of each of nanowires. Thus, it is possible to build a minute nanonetwork utilizing the properties of carbon nanotubes as they are. At the same time, a functional layer having at least one layer of a modified graphene sheet is provided around the carbon nanotube formed as the core portion. Thus, bonds of carbons with one another are intertangled sufficiently, so that the functional layer is retained stably on the core portion while the functional layer is firmly connected to other nanowires. Thus, it is possible to obtain a stable and solid nanonetwork. Further, a large number of bonds are formed in the surface of the modified graphene sheet forming the functional layer. Accordingly, it is also easy to carry out chemical decoration.

[Third Aspect of the Invention]

The third aspect of the invention is a carbon structure having a multi-walled carbon nanotube having at least two layers of graphene sheets, and an amorphous carbon area at which a graphene sheet forming an outermost layer of the carbon nanotube is partially connected with at least one graphene sheet forming at least one inner layer of the carbon nanotube. That is, the carbon structure has a feature in that an amorphous carbon area is provided to extend from the graphene sheet forming the outer layer to one or more layers of graphene sheets inside the outer layer.

FIG. 13 is a schematically enlarged sectional view showing an embodiment of a carbon structure according to the third aspect of the invention. As shown in FIG. 13, in the carbon structure, amorphous carbon areas D and E are disposed at opposite ends of a multi-walled carbon nanotube 102 having three layers of graphene sheets 102a, 102b and 102c. The amorphous carbon areas D and E are connected to the graphene sheets 102a, 102b and 102c. Incidentally, in the third aspect of the invention, it will go well so long as the graphene sheet forming the outermost layer and at least one of the graphene sheets forming the inner layers are partially connected through an amorphous carbon area. The graphene sheet forming the outermost layer does not have to be connected to all the graphene sheets forming the inner layers. In addition, the position where the graphene sheet forming the outermost layer is connected to at least one of the graphene sheets forming the inner layers is not limited to the “opposite ends” shown in FIG. 13. In the third aspect of the invention, the connection position may be formed in any one of “only one end”, “only the middle”, “the opposite ends and the middle”, and others.

In a carbon nanotube according to the related art, a band structure in the surface of a graphene sheet allows an electric current to flow into the surface. Therefore, in the case of a multi-walled carbon nanotube, a current does not flow into graphene sheets unless the graphene sheets come in contact with one another in their end portions to thereby form a conductive band. In this case, the electric conductivity belonging to the multi-walled carbon nanotube is utilized only in the outermost layer.

On the other hand, according to the third aspect of the invention, the amorphous carbon areas D and E are electrically connected not only to the surface-side graphene sheet 102c but also to the inner graphene sheets 102b and 102a. Accordingly, a current can be made to flow not only into the graphene sheet 102c in the surface of the multi-walled carbon nanotube 102 but also into the graphene sheets 102b and 102a in the inner layers through the amorphous carbon areas D and E. Thus, the electric current density and the maximum applied current value can be increased.

In addition, graphene sheets having structures different in conductivity properties and semiconductor properties may be combined as the plurality of graphene sheets 102a, 102b and 102c forming the multi-walled carbon nanotube 102. In this case, the states where the outer layer and the inner layers are connected through the amorphous carbon areas D and E are made different from each other suitably by position (for example, an amorphous carbon area connecting only to the graphene sheet 102c, and an amorphous carbon area connecting to all the graphene sheets 102a, 102b and 102c are provided, while the properties of the graphene sheets are made different from one another so that the graphene sheets have conductivity, semiconductivity and conductivity in the order of descending from the upper layer by way of example). Thus, a semiconductor device or an electronic circuit can be formed.

The method for providing the amorphous carbon areas D and E in the multi-walled carbon nanotube 102 can be implemented fundamentally in the same manner as the production method for producing a nanowire according to the first aspect of the invention, that is, in accordance with the fourth aspect of the invention. Not to say, the amorphous carbon areas D and E are not necessarily derived from graphene sheets of the multi-walled carbon nanotube. Even if amorphous carbon is introduced from the outside, the carbon structure according to the third aspect of the invention can be produced. However, according to the fourth aspect of the invention, it is possible to easily produce the carbon structure according to the third aspect of the invention with firm bonding among the graphene sheets.

Incidentally, when the carbon structure according to the third aspect of the invention is produced according to the fourth aspect of the invention, a graphene sheet in which an amorphous carbon area has been formed is, not to say, interpreted as “modified”. Therefore, such a carbon structure can be regarded as a nanowire according to the first aspect of the invention. Thus, the carbon structure also has effects and functions as the first aspect of the invention.

<Fourth Aspect of the Invention>

The fourth aspect of the invention is a method for producing a nanowire having a feature in that at least a modification treatment is carried out on a multi-walled carbon nanotube having at least two layers of graphene sheets so as to produce a nanowire having a core portion and a functional layer. The core portion has a carbon nanotube having at least one layer of a graphene sheet. The functional layer is formed around the core portion and has at least one layer of a modified graphene sheet in which a graphene sheet has been modified.

In the fourth aspect of the invention, a multi-walled carbon nanotube can be formed into a nanowire in which at least one layer of a graphene sheet originally derived from a carbon nanotube is modified into a functional layer, while a carbon nanotube structure of a graphene sheet structure in the inner layer can be utilized. Thus, the functional layer is retained stably in the state where the functional layer is intertangled with the carbon nanotube formed as the core portion while keeping the structure of the graphene sheet formed as a base to some extent.

The fourth aspect of the invention will be described with its constituent elements into which the fourth invention is classified.

<Multi-walled Carbon Nanotube>

In the invention, a multi-walled carbon nanotube having at least two layers of graphene sheets is used to produce a nanowire.

The length of a carbon nanotube to which the invention can be applied is not limited specifically. A carbon nanotube having a length ranging from 10 nm to 1,000 μm is generally used, and a carbon nanotube having a length ranging from 100 nm to 100 μm is preferably used. The diameter (thickness) of the carbon nanotube is not limited specifically. A carbon nanotube having a diameter ranging from 1 nm to 1 μm is generally used. For applications in which a carbon nanotube is desired to have moderate flexibility, a carbon nanotube having a diameter ranging from 3 nm to 500 nm is preferably used.

In a carbon nanotube left in the state where it was produced, impurities such as amorphous carbon or a catalyst are mixed therein. It is therefore preferable that those impurities are removed by refining. It should be noted that the effects of the invention are not restricted by the existence of impurities.

The number of layers of graphene sheets in a carbon nanotube to which the invention can be applied is preferably four or more in order to allow a carbon nanotube formed as a core portion to exist stably and in order to form a uniform functional layer around the core portion and having a modified graphene sheet.

The form of the carbon nanotube may be a coil form in which the carbon nanotube as a whole is shaped into a spiral, or a nanobeads form in which a tube is provided in the center while spherical beads are penetrated by the tube.

By a modification treatment which will be described later, some of the plurality of graphene sheets in the multi-walled carbon nanotube are modified into modified graphene sheets, while the rest is formed as a core portion. The carbon nanotube forming the core portion may be a single-walled carbon nanotube or a multi-walled carbon nanotube. In addition, the core portion may be conductive or semiconductive.

As described previously, in the carbon nanotube, one graphene sheet may show conductor properties and another graphene sheet may show semiconductor properties in accordance with position of carbon connected when the graphene sheet is formed into a cylinder. In a nanowire according to the invention, a carbon nanotube showing conductor properties or a carbon nanotube showing semiconductor properties may be suitably selected as the core portion in accordance with desired properties.

<Modification Treatment>

In the method for producing a nanowire according to the invention, at least a modification treatment is carried out on the multi-walled carbon nanotube. The term “modification treatment” means a treatment by which modification conforming to the definition “modified” described previously can be performed on a graphene sheet forming the multi-walled carbon nanotube.

Examples of such a modification treatment include a mechanochemical treatment, a heating treatment, an acidic solvent treatment, and an ultrasonic treatment. However, when only the acidic solvent treatment and/or the ultrasonic treatment are performed, not only does it take much time, but also the structure of a side surface of a carbon nanotube may be modified so excessively that the carbon nanotube is cut off. On the other hand, when the mechanochemical treatment is carried out, a graphene sheet in a side surface of a multi-walled carbon nanotube can be modified in a short time while the length of the carbon nanotube is kept. It is therefore preferable that the mechanochemical treatment is carried out as the modification treatment.

Further, in addition to the mechanochemical treatment, it is preferable that at least one treatment selected from a group of the heating treatment, the acidic solvent treatment, and the ultrasonic treatment is combined. Of them, it is particularly preferable that at least the heating treatment is combined.

When these treatments are combined, all or a desired combination of the treatments may be performed simultaneously or sequentially in a desired order. At this time, the mechanochemical treatment which is high in effect for modifying a graphene sheet is preferably performed initially also in the case where other treatments are performed at the same time as the mechanochemical treatment.

Examples of combinations of these treatments may include the following treatment procedures. However, the invention is not limited to the procedures. Incidentally, when a plurality of treatments are enclosed within a pair of parentheses in the following examples, it means that these treatments are performed simultaneously.

(mechanochemical treatment)→(acidic solvent treatment)→(heating treatment)→(ultrasonic treatment)

(mechanochemical treatment)→(acidic solvent treatment)→(ultrasonic treatment)→(heating treatment)

(mechanochemical treatment)→(acidic solvent treatment, and ultrasonic treatment)→(heating treatment)

(mechanochemical treatment)→(acidic solvent treatment, and heating treatment)→(ultrasonic treatment)

(mechanochemical treatment)→(acidic solvent treatment, heating treatment, and ultrasonic treatment)

(mechanochemical treatment, acidic solvent treatment, and heating treatment)→(ultrasonic treatment)

(mechanochemical treatment)→(acidic solvent treatment)→(heating treatment)

(mechanochemical treatment)→(heating treatment)→(acidic solvent treatment)

(mechanochemical treatment)→(acidic solvent treatment, and heating treatment)

(mechanochemical treatment)→(heating treatment)→(ultrasonic treatment)

(mechanochemical treatment)→(heating treatment)

(mechanochemical treatment, and heating treatment)

Next, the details for every modification treatment will be described.

(Mechanochemical Treatment)

The mechanochemical treatment in the invention means that a chemical change can be formed by application of mechanical action. More specifically, it means that mechanical external force is applied to a multi-walled carbon nanotube so that the network structure of six-membered rings forming a graphene sheet in the surface or graphene sheets over several layers from the surface is broken partially. In the invention, by performing the mechanochemical treatment, defects (radicals) are generated in the surface of the carbon nanotube. Thus, it is possible to obtain a nanowire according to the first aspect of the invention including a core portion and a functional layer formed around the core portion, the core portion having a carbon nanotube having at least one layer of a graphene sheet, the functional layer having at least one layer of a modified graphene sheet.

The mechanochemical treatment is classified into a dry type and a wet type. In the invention, either type can be adopted, or both the types can be combined. Examples of a dry type mechanochemical treatment include a treatment using a ball mill (hereinafter, occasionally referred to as “ball mill treatment” simply), and a treatment of grinding with a pestle and a mortar (hereinafter, occasionally referred to as “mortar treatment” simply). On the other hand, examples of a wet type treatment include a treatment in which a multi-walled carbon nanotube dispersed into a suitable dispersion medium is stirred by a stirrer or a kneader having high shearing force, and a ball mill treatment in the state where a multi-walled carbon nanotube is dispersed in a medium. When the mechanochemical treatment is performed in combination with and simultaneously with the acidic solvent treatment or the ultrasonic treatment, the acidic solvent treatment or the ultrasonic treatment may be carried out simultaneously and in combination while the wet type mechanochemical treatment is carried out with a multi-walled carbon nanotube dispersed into an acidic solvent or a dispersion medium for the ultrasonic treatment.

In the mechanochemical treatment, stress or time in the mechanical treatment such as the ball mill treatment or the mortar treatment is changed so that the defects (radical formation portions) in the surface of the carbon nanotube can be increased or decreased, whereby the fusion state (of gaps among nets) caused by the heating treatment or the like following the mechanochemical treatment can be controlled when the mechanochemical treatment is combined with other treatments. The multi-walled carbon nanotube is usually regarded as difficult to react. If the mechanochemical treatment is performed in advance on the multi-walled carbon nanotube, the subsequent fusion is brought forward easily. Further, the electric properties can be altered. That is, as the mechanochemical treatment is carried out more strongly, the electric resistance value of the network can be increased.

Specific treatment conditions for the mechanochemical treatment may be adjusted suitably in accordance with desired properties, the kind of a multi-walled carbon nanotube used as a raw material, other treatments to be combined, and the conditions of the combined treatments. Generally, by prolonging the time to apply stress and increasing the magnitude of the stress, the degree of modification can be increased.

(Acidic Solvent Treatment)

The acidic solvent treatment in the invention means that a multi-walled carbon nanotube is treated with an acidic solvent. Examples of an available acidic solvent include nitric acid, sulfuric acid, hydrochloric acid, phosphoric acid, dichromic acid, and mixed acid of these acids. To obtain a sufficient modification effect, it is preferable that nitric acid, or mixed acid of dichromic acid and sulfuric acid is used, and it is particularly preferable that high concentration acid is used.

Specific treatment conditions for the acidic solvent treatment may be adjusted suitably in accordance with desired properties, the kind of a multi-walled carbon nanotube used as a raw material, other treatments to be combined, and the conditions of the combined treatments. For example, by prolonging the treatment time, the degree of modification can be increased.

(Heating Treatment)

The heating treatment in the invention means a treatment in which a multi-walled carbon nanotube is heated directly or after the multi-walled carbon nanotube is dispersed in a suitable dispersion medium. The heating treatment is preferably carried out subsequently to the mechanochemical treatment in the point that micro defects produced in the mechanochemical treatment are changed into partial breaking by the heating treatment so that modification can be brought forward efficiently. In addition, by prolonging the time of the heating treatment following the mechanochemical treatment or increasing the temperature, portions formed into radicals by the mechanochemical treatment are easily brought into a molten state. Thus, the structure of a nanowire obtained can be controlled properly. Further, the electric properties can be altered. That is, as the heating treatment is carried out more strongly, the electric resistance value of the network can be increased.

Specific treatment conditions for the heating treatment may be adjusted suitably in accordance with desired properties, the kind of a multi-walled carbon nanotube used as a raw material, other treatments to be combined, and the conditions of the combined treatments. Generally, by performing the heating treatment at a higher temperature and for a longer time, the degree of modification can be increased.

(Ultrasonic Treatment)

The ultrasonic treatment in the invention means a treatment in which a multi-walled carbon nanotube is dispersed by an ultrasonic dispersion apparatus after the multi-walled carbon nanotube is dispersed in a suitable dispersion medium. An available ultrasonic dispersion apparatus is not limited specifically. In addition, when nanowires formed into a network structure by other treatments are dispersed by the ultrasonic treatment, each nanowire according to the invention can be extracted individually.

Specific treatment conditions for the ultrasonic treatment may be adjusted suitably in accordance with desired properties, the kind of a multi-walled carbon nanotube used as a raw material, other treatments to be combined, and the conditions of the combined treatments. Generally, by performing the ultrasonic treatment at a higher frequency and for a longer time, the degree of modification can be increased.

(Other Treatments)

Other than the mechanochemical treatment, the heating treatment, the acidic solvent treatment and the ultrasonic treatment, various treatments by which a graphene sheet forming a multi-walled carbon nanotube can be modified can be adopted as the modification treatment. For example, addition reaction or substitution reaction to the graphene sheet by chemical reaction can be mentioned as the modification treatment. In addition, subsequently to the respective treatments described previously, structures such as various functional groups, molecules or atoms may be added to modified carbon atoms of a modified graphene sheet, or molecules may be adsorbed to functional groups bonded to the modified carbon atoms of the modified graphene sheet. In such a manner, desired properties can be given to a nanowire obtained.

By adjusting the treatment time, the treatment temperature, the load, the kind of acid, and the acid treatment time and temperature in the respective modification treatments described above, the quantity of modification in the side surface of a graphene sheet as an outer layer in a multi-walled carbon nanotube can be controlled. Further, by performing the treatments for a long time, denaturation can be produced even on a carbon nanotube as a core portion. Thus, properties such as electric resistance can be adjusted (that is, a carbon structure according to the third aspect of the invention can be obtained).

In addition, in this course, a plurality of nanowires can be fused to one another on the side surfaces of their modified graphene sheets. Thus, a solid network of carbon nanotubes can be constructed (that is, a nanonetwork according to the second aspect of the invention can be obtained).

Further, if the concentration of a multi-walled carbon nanotube is increased in the case where various treatments are performed in liquid, the density of a structure can be increased, and hence gaps in the network can be reduced. In such a manner, by adjusting the concentration of the carbon nanotube in the liquid, the structure of the obtained nanowire can be controlled properly.

Further, by adding amorphous carbon or the like separately, a network having a large fused surface can be obtained.

(Degree of Modification)

When such modification treatments are performed, the degree of modification can be set to the following degrees 1) to 3) by combining various modification treatments suitably and/or by selecting the conditions of the modification treatments suitably.

1) The modification treatments are carried out to such a degree that an obtained nanowire is brought into the state where hollow tubular portions surrounded by a graphene sheet derived from a carbon nanotube of a core portion of the nanowire and node portions shaped to narrow the hollow tubular portions are formed alternately in the nanowire in the longitudinal direction of the nanowire, that is, into the state shown in FIG. 6.

By carry out the modification treatments to such a degree, a nanowire according to the fourth embodiment can be obtained.

2) The modification treatments are carried out to such a degree that defects are produced at least in a surface of the multi-walled carbon nanotube so that a carbon nanotube having a hollow tubular portion surrounded by a graphene sheet is left as the core portion while a layer having at least one layer of a modified graphene sheet in which a graphene sheet has been modified is formed around the core portion. Particularly, it is preferable that the modification treatments are carried out to such a degree that the modified graphene sheet has an amorphous carbon area.

By carrying out the modification treatments to such a degree, nanowires according to the first to third embodiments can be obtained.

3) The modification treatments are carried out to such a degree that defects are produced at least in a surface of the multi-walled carbon nanotube so that a carbon nanotube having a hollow tubular portion surrounded by a graphene sheet is left as the core portion while a layer having at least one layer of a modified graphene sheet in which a graphene sheet has been modified and which has an amorphous carbon area is formed around the core portion, and there is formed a network structure in which a plurality of such nanowires are fused to adhere to one another through such amorphous carbon areas.

By carrying out the modification treatments to such a degree, a nanonetwork according to the second aspect of the invention can be obtained.

By such modification treatments, a nanonetwork having a network structure in which nanowires are bonded to one another is mainly formed. However, if a network structure is not intended to be formed, the time of the mechanochemical treatment or the concentration of the carbon nanotube may be adjusted. Alternatively, individual nanowires may be sorted out of the obtained nanonetwork by use of ultrasonic separation or the like.

In the modification treatments, it is preferable that a multi-walled carbon nanotube used has three or more layers, and a functional layer in an obtained nanowire has two or more layers of modified graphene sheets.

Specific procedures of the modification treatments will be mentioned below by way example. However, the fourth aspect of the invention is not limited to the following procedures.

### EXAMPLE 1 OF PROCEDURE OF MODIFICATION TREATMENTS

A multi-walled carbon nanotube is put into a mortar and ground with a pestle for about 5 minutes in advance. Thus, the mechanochemical treatment is achieved. Next, the obtained product is added to concentrated nitric acid (60%), and refluxed in an oil bath at 120° C. for a long time (not shorter than 8 hours). After that, precipitate is obtained by centrifugation. Last, the precipitate is dispersed again into purified water.

### EXAMPLE 2 OF PROCEDURE OF MODIFICATION TREATMENTS

A carbon nanotube is stirred by a ball mill in advance. Thus, the mechanochemical treatment is achieved. Next, the obtained product is put into a furnace, and baked at 300° C. for 20 minutes.

[Fifth Aspect of the Invention]

The fifth aspect of the invention is a method for producing a nanonetwork having a feature in that a nanowire (nanowire A) according to the first aspect of the invention in which the modified graphene sheet has an amorphous carbon area and a nanowire (nanowire B) according to the first aspect of the invention or a carbon nanotube are crossed so that the amorphous carbon area in the nanowire A is in contact with the nanowire B or the carbon nanotube, and the crossing portion is irradiated with a beam of electrons so as to electrically connect the nanowire A with the nanowire B or the carbon nanotube.

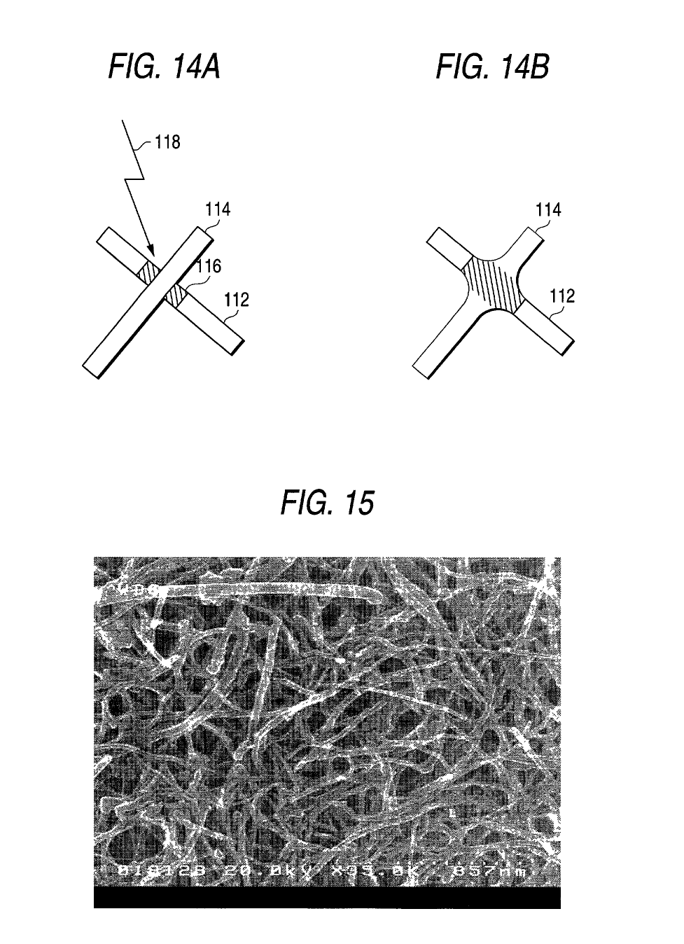

FIGS. 14A and 14B show schematically explanatory views for explaining the principle of the fifth aspect of the invention. In FIG. 14A, the reference numeral 112 represents a nanowire A, particularly a nanowire according to the first aspect of the invention, in which a modified graphene sheet has an amorphous carbon area 116. On the other hand, the reference numeral 114 represents a connection target, which is a nanowire B or a carbon nanotube. When the connection target 114 is a nanowire B, that is, a nanowire according to the first aspect of the invention, there is no preference to the fact that the modified graphene sheet in the nanowire B has or does not have an amorphous carbon area.

As shown in FIG. 14A, the nanowire A 112 and the connection target 114 are crossed so that the amorphous carbon area 116 in the nanowire A 112 is in contact with the connection target 114. When the whole of the nanowire A 112 is coated with the amorphous carbon area 116, the contact position with the connection target 114 is not limited.

Then, when the crossing portion between the nanowire A 112 and the connection target 114 is irradiated with an electron beam 118, the amorphous carbon in the amorphous carbon area 116 is fused to the connection target 114 so as to bridge both the nanowire A 112 and the connection target 114 as shown in FIG. 14B. Thus, both the nanowire A 112 and the connection target 114 are connected extremely firmly in comparison with the related-art method in which a carbon nanotube is fused simply by use of an aggregate of amorphous carbon.

In such a manner, the connection between the nanowire A 112 and the connection target 114 is based on amorphous carbon derived from the graphene sheet of the nanowire A 112. Thus, both the nanowire A 112 and the connection target 114 can be electrically and firmly connected by simply irradiating the crossing portion with an electron beam, so that a solid nanonetwork can be produced easily.

Particularly, when nanowires each having an amorphous carbon area according to the invention are connected with each other, both the nanowires can be bonded through modified graphene sheets intertangled with carbon nanotubes as their core portions. Thus, stable bonding can be formed.

When a plurality of nanowires (and further carbon nanotubes as their core portions) are connected to one another through modified graphene sheets, the modified graphene sheets are fused to one another. Electricity flows mainly in the surface. Thus, when the surfaces of the nanowires according to the invention are fused and altered thus, a current which has flowed in the metallic carbon nanotube surface so far comes to flow into amorphous carbon in the surface. As a result, the surface electric properties of the carbon nanotube change. In such a manner, nanowires having electric properties different from those of untreated carbon nanotubes can be obtained.

In the fifth aspect of the invention, even when a nanowire used has such a modification state that it is difficult to confirm whether the nanowire is attributed to the invention or not, such a nanowire can be used without any problem because the modification is advanced simultaneously by irradiation with an electron beam. That is, when a graphene sheet including latent defects caused by the modification treatment is irradiated with an electron beam, the graphene sheet is formed into amorphous while fusion to a bonding target is advanced at the same time. For example, the mechanochemical treatment is carried out on multi-walled carbon nanotubes in advance. Next, an electron beam is hit on contact points of the multi-walled carbon nanotubes so that the multi-walled carbon nanotubes can be fused to each other.

[Sixth Aspect of the Invention]

The six aspect of the invention is an electronic device including a nanowire according to the first aspect of the invention used as electric wiring. Even if the nanowire is used singly as electric wiring, a functional layer can be formed around a carbon nanotube by the denaturation of a modified graphene sheet itself or by the bonding of ligands to bonds. Thus, the nanowire can be applied to electric wiring of an electric device, as a conductive wire with insulating coating or a nanowire having various other functions.

Nanowires, nanonetworks and carbon structures according to the invention are expected to be applied not only to electric wiring but also to extremely wide technical fields. Description will be made on various applications of nanowires, nanonetworks and carbon structures according to the invention, other than the applications described above.

1) Electronics Field

Nanowires, nanonetworks and carbon structures according to the invention can be used as electrodes, conducting wires, electric wiring, and electronic elements. Since a nanonetwork according to the invention is formed by fusion, the structure is so stable that the shape is easily kept even if it is not retained by a polymeric film or the like. The nanowire according to the invention is different from a general (untreated) carbon nanotube in the point that the resistance of the network can be adjusted desirably in accordance with the producing conditions. Further, the properties as a carbon nanotube are also left in the nanowire according to the invention. Thus, when molecules designed for molecular-scale electronics are inserted as the other materials in gaps between carbon nanotubes, molecular switches, molecular memories and molecular processors can be implemented.

In comparison with silicon devices in a related-art method, such devices implemented by nanowires according to the invention have many excellent advantages as follows. That is, carbon nanotubes, which are not wiring fixed to a substrate but wiring in the devices, are so soft that the carbon nanotubes can be made close/distant desirably. The carbon nanotube wiring has a diameter smaller than the resolving power of lithography. Wiring can be achieved by use of chemical bonding. Owing to such advantages, the nanowires can have direct access to small molecular size of, for example, not larger than 5 nm. Thus, by use of the nanowires according to the invention, a large-scale electronic integrated circuit can be produced at low cost, with ease and with high density.

2) Various Structural Materials

Nanowires and nanonetworks according to the invention can be used as various structural materials (chassis, frames, and other mechanical parts) by use of their toughness. Particularly, nanowires having hollow portions are so lightweight and tough that the nanowires can be preferably applied to structural materials in various fields where lightweight and toughness are required.

On the other hand, it is generally described that high toughness can be obtained only by dispersing filler into resin. However, if a nanonetwork formed by structuralizing a plurality of nanowires described above is disposed in a matrix (resin), the nanowires corresponding to the filler forms a solid structure in the matrix so as to show extremely high toughness as a whole. Further in the invention, such structures are fused to one another so as to form an extremely tough organization. Thus, filler-containing resin which contains a nanonetwork according to the invention as an alternative to filler can be preferably applied also to structural materials for which metal, particularly lightweight and high-strength noble metal such as titanium has been used.

### EXAMPLES

The invention will be described below more specifically with its examples.

### Example 1

(Step 1)

A multi-walled carbon nanotube (purity 90% to 95%) of 0.02 g was put into a mortar, and ground with a pestle for 5 minutes (mechanochemical treatment).

(Step 2)

The multi-walled carbon nanotube obtained by (Step 1) was added to a 25 ml round flask receiving concentrated nitric acid (60%) of 14 g, and dispersed well by an ultrasonic dispersion apparatus with power of 3 W. Thus, a dispersion of the carbon nanotube was obtained (acidic solvent treatment, and ultrasonic treatment).

(Step 3)

The dispersion of the multi-walled carbon nanotube obtained by (Step 2) was refluxed in an oil bath at 120° C. for 12 hours (heating treatment).

(Step 4)

Two drops of the dispersion obtained by (Step 3) were thrown down to one side of a mica substrate, and applied widely by use of a spin coater (rotary film formation apparatus) so as to be formed into a film. At this time, the speed of rotation of the spin coater was adjusted suitably to remove excessive dispersion on the mica substrate. Thus, networked nanowires (nanonetwork) were obtained. FIG. 11 shows the obtained nanowires (nanonetwork) observed by scanning electron microscope. As is understood from FIG. 11, the nanowires are fused to one another through amorphous carbon derived from modified graphene sheets twining around the surfaces of the nanowires. Thus, an extremely solid network is formed.

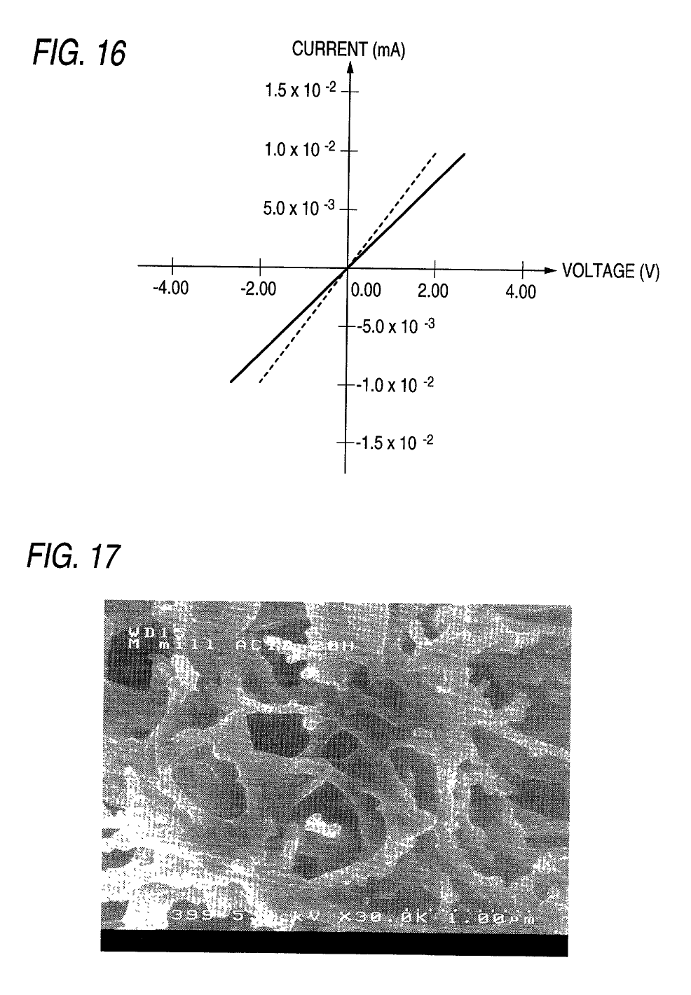

In addition, the nanowires (nanonetwork) were disposed in one layer between two gold electrodes (18 μm distant, and 80 μm wide). A voltage was applied to the nanowires so as to confirm their electric properties. This result is shown by the solid line in FIG. 16.

### Reference Example

(Step 1)

A multi-walled carbon nanotube (purity 90% to 95%) of 0.02 g was added to a 25 ml round flask receiving concentrated nitric acid (60%) of 14 g, and dispersed well by an ultrasonic dispersion apparatus with power of 3 W. Thus, a dispersion of the carbon nanotube was obtained.

(Step 2)

The dispersion of the multi-walled carbon nanotube obtained by (Step 1) was refluxed in an oil bath at 120° C. for 20 hours (heating treatment).

(Step 3)

Two drops of the dispersion obtained by (Step 2) were thrown down to one side of a mica substrate, and applied widely by use of a spin coater (rotary film formation apparatus) so as to be formed into a film. At this time, the speed of rotation of the spin coater was adjusted suitably to remove excessive dispersion on the mica substrate. Thus, networked nanowires (nanonetwork) were obtained. FIG. 15 shows the obtained nanowires (nanonetwork) observed by scanning electron microscope. As is understood from FIG. 15, the nanowires exist in the state where the nanowires lie on top of one another simply as they are, and the nanowires are connected to one another only in contact points of crossing portions. That is, in this example, a sufficient modification treatment is not achieved, and nanowires (nanonetwork) according to the invention are not formed.

In addition, the nanowires (nanonetwork) were disposed equally in one layer between two gold electrodes (18 μm distant, and 80 μm wide). A voltage was applied to the nanowires so as to confirm their electric properties. This result is shown by the broken line in FIG. 16.

As is apparent from FIG. 16, the electric resistance of the nanonetwork in Example 1 where the modification treatment was achieved is higher than that in the reference example where a sufficient modification treatment was not achieved. The resistance value calculated in the reference example was 1.73×10⁵ Ω, and that in Example 1 was 2.45×10⁵ Ω.

### Example 2

(Step 1)

A multi-walled carbon nanotube (purity 90% to 95%) of 0.02 g was put into a mortar, and ground with a pestle for 10 minutes (mechanochemical treatment).

(Step 2)

The multi-walled carbon nanotube obtained by (Step 1) was added to a 25 ml round flask receiving concentrated nitric acid (60%) of 14 g, and dispersed well by an ultrasonic dispersion apparatus with power of 3 W. Thus, a dispersion of the carbon nanotube was obtained (acidic solvent treatment, and ultrasonic treatment).

(Step 3)

The dispersion of the multi-walled carbon nanotube obtained by (Step 2) was refluxed in an oil bath at 120° C. for 20 hours (heating treatment).

(Step 4)

Two drops of the dispersion obtained by (Step 3) were thrown down to one side of a mica substrate, and applied widely by use of a spin coater (rotary film formation apparatus) so as to be formed into a film. At this time, the speed of rotation of the spin coater was adjusted suitably to remove excessive dispersion on the mica substrate. Thus, networked nanowires (nanonetwork) were obtained. FIG. 17 shows the obtained nanowires (nanonetwork) observed by scanning electron microscope. As is understood from FIG. 17, the nanowires are fused to one another through amorphous carbon derived from modified graphene sheets twining around the surfaces of the nanowires. Thus, an extremely solid network is formed. This fused state is further developed in comparison with that in the nanowires (nanonetwork) in Example 1. It is therefore understood that the modification of the graphene sheets is further developed.

As described above, according to the first aspect of the invention, it is possible to provide a nanowire in which the properties belonging to a carbon nanotube can be utilized while a functional layer showing an additional function has been added stably.

According to the second aspect of the invention, it is possible to easily obtain a network which has excellent properties derived from the nanowires according to the first aspect of the invention and which is stable and solid.

According to the third aspect of the invention, it is possible to provide a carbon structure in which respective graphene sheets included as lamination layers in a multi-walled carbon nanotube can be utilized efficiently.

According to the fourth aspect of the invention, it is possible to produce a nanowire having a functional layer efficiently.

According to the fifth aspect of the invention, it is possible to form a nanonetwork by connecting a nanowire and a nanowire or a nanotube easily and solidly.

According to the sixth aspect of the invention, it is possible to provide an electronic device having excellent properties derived from the nanowire according to the first aspect of the invention.

What is claimed is:

1. A nanowire comprising:
a core portion having a carbon nanotube having at least one layer of a graphene sheet; and
a functional layer formed around the core portion and having at least one layer of a modified graphene sheet.

2. The nanowire according to claim 1, wherein the modified graphene sheet has an amorphous carbon area.

3. The nanowire according to claim 1, wherein a structure different in structure from the graphene sheet is bonded with modified carbon atoms in the modified graphene sheet.

4. The nanowire according to claim 3, wherein the structure is a functional molecule.

5. The nanowire according to claim 1, wherein the functional layer has insulating properties.

6. The nanowire according to claim, wherein the functional layer has semiconductor properties.

7. The nanowire according to claim 1, wherein another material is dispersed in the functional layer.

8. The nanowire according to claim 7, wherein the another material is a doping agent.

9. The nanowire according to claim 7, wherein the another material is a functional molecule.

10. The nanowire according to claim, wherein a predetermined material is incorporated into a hollow tubular portion of the carbon nanotube forming the core portion.

11. The nanowire according to claim, wherein the carbon nanotube forming the core portion has a structure showing semiconductor properties.

12. The nanowire according to claim, wherein the carbon nanotube forming the core portion has a structure showing conductor properties.

13. The nanowire according to claim 1, further comprising a second functional layer provided as an outer layer than the functional layer, the second functional layer being different in structure from the functional layer.

14. A nanonetwork comprising a plurality of nanowires each having:
a core portion having a carbon nanotube having at least one layer of a graphene sheet; and
a functional layer formed around the core portion and having at least one layer of a modified graphene sheet in which a graphene sheet has been modified,
wherein the functional layers adhere to one another at least in side surfaces of the nanowires so as to form a network structure.

15. A carbon structure comprising:
a multi-walled carbon nanotube having at least two layers of graphene sheets; and
an amorphous carbon area at which a graphene sheet forming an outermost layer of the carbon nanotube is partially connected with at least one graphene sheet forming an inner layer of the carbon nanotube.

16. A method for producing a nanowire, comprising the step of:
carrying out at least a modification treatment on a multi-walled carbon nanotube having at least two layers of graphene sheets so as to produce a nanowire having a core portion and a functional layer, the core portion having a carbon nanotube having at least one layer of the graphene sheets, the functional layer formed around the core portion and having a modified graphene sheet originated from at least one of the graphene sheets around the core portion.

17. The method according to claim 16, wherein the modification treatment is a mechanochemical treatment.

18. The method according to claim 17, wherein the modification treatment is a combination of the mechanochemical treatment and at least one treatment selected from a group of a heating treatment, an acidic solvent treatment, and an ultrasonic treatment.

19. The method according to claim 16, wherein the modification treatment is carried out till hollow tubular portions surrounded by a graphene sheet originated from the carbon nanotube of the core portion and node portions separating the hollow tubular portions are formed alternately in the nanowire in a longitudinal direction of the nanowire.

20. The method according to claim 16, wherein the modification treatment is carried out till defects are produced at least in a surface of the multi-walled carbon nanotube so that a carbon nanotube having a hollow tubular portion surrounded by a graphene sheet is left as the core portion while the modified graphene sheet originated from at least one of graphene sheets is formed around the core portion.

21. The method according to claim 20, wherein the modified graphene sheet has an amorphous carbon area.

22. The method according to claim 16, wherein the modification treatment is carried out till defects are produced at least in a surface of the multi-walled carbon nanotube so that a carbon nanotube having a hollow tubular portion surrounded by a graphene sheet is left as the core portion while the modified graphene sheet originated from at least one of graphene sheets and which has an amorphous carbon area is formed around the core portion, and a network structure in which a plurality of such nanowires adhere to one another through the amorphous carbon areas is formed.

23. The method according to claim 16,
wherein the multi-walled carbon nanotube has at least three layers; and
wherein the functional layer has at least two layers of modified graphene sheets.

24. A method for producing a nanonetwork, comprising the steps of:
providing a nanowire A having:
a core portion having a carbon nanotube having at least one layer of a graphene sheet; and
a functional layer formed around the core portion and having at least a modified graphene sheet which has an amorphous carbon area,
providing nanowire B having:
a core portion having a carbon nanotube having at least one layer of a graphene sheet; and
a functional layer formed around the core portion and having at least one layer of a modified graphene sheet,
crossing the nanowire A and one of the nanowire B and a carbon nanotube so that an amorphous carbon area in the nanowire A is in contact with the one of the nanowire B and the carbon nanotube; and
irradiating the crossing portion with an electron beam so as to electrically connect the nanowire A with the one of the nanowire B and the carbon nanotube.

25. An electronic device comprising a nanowire having:
a core portion having a carbon nanotube having at least one layer of a graphene sheet; and
a functional layer formed around the core portion and having at least one layer of a modified graphene sheet,
wherein the nanowire is used as electric wiring.
